(19) United States
(12) Patent Application Publication
(10) Pub. No.: US 2014/0364115 A1
(43) Pub. Date: Dec. 11, 2014

(54) INTELLIGENT EDGE DEVICE

(71) Applicants: Mark W Fidler, Granite Bay, CA (US); Kenneth Lloyd Taggard, Roseville, CA (US)

(72) Inventors: Mark W Fidler, Granite Bay, CA (US); Kenneth Lloyd Taggard, Roseville, CA (US)

(21) Appl. No.: 14/372,510

(22) PCT Filed: Jan. 27, 2012
(86) PCT No.: PCT/US2012/022866

§ 371 Date: Jul. 16, 2014

(51) Int. Cl. H04W 8/02; H04W 8/18

(52) U.S. Cl. CPC H04W 8/02; H04W 8/186
USPC 455/432.1

(57) ABSTRACT

An example system includes a controller and a plurality of intelligent edge devices. The controller is to adopt the plurality of intelligent edge devices and inform each of the plurality of intelligent edge devices which of the other plurality of intelligent edge devices are proximate to the intelligent edge device. The plurality of intelligent edge devices are each to (i) create a trusted relationship with the other plurality of intelligent edge devices that are proximate to the intelligent edge device, (ii) collect baseline persona information for a client connected to the intelligent edge device, (iii) collect dynamic persona information for the client connected to the intelligent edge device, (iv) store the baseline and dynamic persona information, and (v) transmit the baseline and dynamic persona information for the client to at least one of the other plurality of intelligent edge devices that are proximate to the intelligent edge device.

### BACKGROUND

In a typical communications system, an edge device, such as access point, router, and/or switch, is located at the periphery of the network. The edge device provides an entry point to the network, and transfers data between the network and clients via wired/wireless mediums and various communication protocols. For example, a wireless access point may be communicatively coupled to a workstation and a web server, and be configured to propagate data to and from the workstation and the web server via the IEEE 802.11x protocol and one or more communication paths.

In systems where multiple edge devices are utilized, each edge device typically services a limited geographic coverage area. If a client moves from a first edge device's coverage area to a second edge device's coverage area, the client is considered to be roaming, and roaming procedures are initiated to transition the service from the first edge device to the second edge device. That is, the service is “handed-off” from the first edge device to the second edge device to enable the client's session with the network to persist notwithstanding the client's movement.

### BRIEF DESCRIPTION OF THE DRAWINGS

Example embodiments are described in the following detailed description and in reference to the drawings, in which:

FIG. 1 depicts a system in accordance with an embodiment;

FIG. 2 depicts an intelligent edge device in accordance with an Embodiment;

FIG. 3 depicts example persona information that may be collected, stored, and distributed by an intelligent edge device in accordance with an embodiment;

FIG. 4 graphically depicts how persona information may be collected, stored, and distributed in accordance with an embodiment;

FIG. 5 graphically depicts how persona information may be collected, stored, and distributed in accordance with another embodiment;

FIG. 6 graphically depicts how persona information may be collected, stored, and distributed in accordance with still another embodiment;

FIG. 7 graphically depicts how persona information may be collected, stored, and distributed in accordance with a further embodiment;

FIG. 8 graphically depicts how persona information may be collected, stored, and distributed in accordance with another embodiment;

FIG. 9 depicts a system in accordance with a further embodiment; and

FIG. 10 depicts a process flow diagram in accordance with an embodiment.

### DETAILED DESCRIPTION

Various embodiments described herein are directed to an intelligent edge device. More specifically, and as described in greater detail below, various embodiments are directed to an intelligent edge device that collects, stores, and distributes baseline and dynamic persona information with other intelligent edge devices without or in partial conjunction with a controller. Contrary to current approaches, this novel and previously unforeseen approach allows up-to-date persona information to be shared between intelligent edge devices without having to rely predominantly on a controller to conduct this function.

In most current communication systems, when a client attaches to a network, the client is authenticated and given a set of parameters, security credentials, service level attributes, and the like (hereinafter “persona information”). When the client roams from a first edge device to a second edge device, the network session persists and the persona information is provided to the second edge device. The persona information, however, is based on the initial status when the client initiated the network session with the first edge device, and does not reflect persona changes that may have occurred since the client initiated the network session (e.g., persona information may have been modified/added based on services the client accessed). Put another way, most current systems are concerned with providing persistent connectivity at the same state as the initial persona and do not provide the same service level, service access, and/or security level as was being provided prior to the client roaming. As a result, the client may not be provided a consistent level of service while roaming.

In the few current systems that may restore all or a portion of the service level that was being provided prior to the client roaming, all traffic is routed through a central controller. For example, an edge device may use a tunnel back procedure to a centralized controller to obtain the current persona information for a client that has entered into the edge device's coverage area. The centralized controller tracks and stores the persona information for all clients in its domain, and the controller informs each edge device of the service level to implement. This process occurs without substantial participation by the edge devices, and therefore creates a bottleneck and resulting latency because the centralized controller is responsible for providing persona information for each associated client. Moreover, the centralized controller is limited in the amount of persona information collected, and therefore does not provide an edge device with a significant amount of useful persona information.

Embodiments described herein address at least the above by utilizing intelligent edge devices that work without or in partial conjunction with a centralized controller. The intelligent edge devices are superior to traditional “non-intelligent” edge devices, insofar as the intelligent edge devices collect, store, and distribute vast amounts of persona information. The persona information may include persona information from when the client initiated the network session (hereinafter “baseline persona information”), as well as persona information modified subsequent to the initiation of the network session (hereinafter “dynamic persona information”). The intelligent edge devices may distribute this baseline and/or dynamic persona information in response to changes in persona information, in response to a request, or periodically. Moreover, the intelligent edge devices may distribute this baseline and/or dynamic persona information directly with one another (i.e., without routing through a centralized controller). Hence, embodiments reduce the edge device's reliance on the controller, if at all, and therefore alleviate the bottleneck and latency issues associated with current systems. In addition, embodiments take into consideration that various persona parameters may be updated, added, and/or removed during a network session, and therefore track and distribute this information so that a client may receive consistent service levels when roaming. Also, embodiments allow for statistical/historical client and network information to be tracked, distributed, and utilized to help optimize the network based on learned behavior. Still further, embodiments provide the same level of service from both a client and a network standpoint, and therefore give the client a seamless roaming experience with respect to service continuity, as well as protect the network as the client roams.

In one example embodiment, a system is provided. The system comprises a controller and a plurality of intelligent edge devices. The controller is configured to adopt the plurality of intelligent edge devices and inform each of the plurality of intelligent edge devices which of the other plurality of intelligent edge devices are proximate to the intelligent edge device. The plurality of intelligent edge devices are each configured to (i) create a trusted relationship with the other plurality of intelligent edge devices that are proximate to the intelligent edge device, (ii) collect baseline persona information for a client connected to the intelligent edge device, (iii) collect dynamic persona information for the client connected to the intelligent edge device, (iv) store the baseline and dynamic persona information for the client connected to the intelligent edge device, and (v) transmit the baseline and dynamic persona information for the client to at least one of the other plurality of intelligent edge devices that are proximate to the intelligent edge device.

In another example embodiment, an intelligent edge device is provided. The intelligent edge device comprises a processing device, a communication interface, and a non-transitory computer readable medium. The communication interface is configured to receive persona information for a client communicatively coupled to the intelligent edge device, and to transmit baseline persona information and dynamic persona information for the client to at least one proximate intelligent edge device in response to receiving a query message requesting information for the client from the proximate intelligent edge device, or in response to persona information changes for the client. The non-transitory computer readable medium is configured to store the baseline persona information and the dynamic persona information for the client communicatively coupled to the intelligent edge device.

In still another example embodiment, a non-transitory computer-readable medium is provided. The non-transitory computer-readable medium comprises instructions that when executed cause a first intelligent edge device to (i) create a trusted relationship with a second intelligent edge device based at least in part on information provided by a controller, (ii) collect and store baseline persona information and dynamic persona information for a client communicatively coupled to the first intelligent edge device, and (iii) transmit, directly to the second intelligent edge device, the baseline persona information and the dynamic persona information for the client.

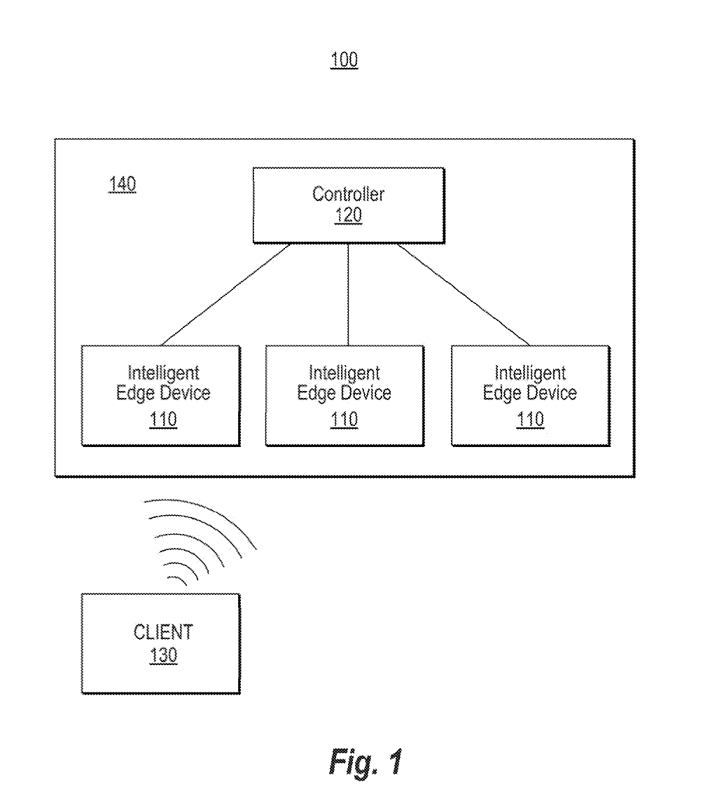

FIG. 1 depicts a system 100 in accordance with one embodiment. It should be readily apparent that the system 100 depicted in FIG. 1 represents a generalized illustration and that other components may be added or existing components may be removed, modified, or rearranged without departing from a scope of the present disclosure. The system 100 comprises a plurality of intelligent edge devices 110, a controller 120, a client 130, and a trusted infrastructure domain 140, each of which is described in greater detail below.

The intelligent edge devices 110 are devices configured to provide an entry point to a network, and further configured to collect, store, and share baseline and/or dynamic persona information with other intelligent edge devices without or in partial conjunction with a controller. For example, the intelligent edge device 110 may be an intelligent wireless access point or intelligent switch. The intelligent edge device 110 may utilize wireless and/or wired mediums to communicate with clients and network infrastructure (e.g., radio frequency (RF), fiber-optic, coaxial, twisted pair, etc.). Furthermore, the intelligent edge devices 110 may utilize various communication protocols to communicate with clients and/or network infrastructure (e.g., 802.11x, TCP/IP, etc.).

The intelligent edge devices 110 are configured to create trusted relationships with other proximate intelligent edge devices 110 and/or with the controller. The intelligent edge devices 110 may obtain knowledge about the proximate intelligent edge devices 110 (i) based on information provided by the controller 120, (ii) based on information gathered by the intelligent edge device 110 via listening to proximate communications and/or implementing one or more discovery algorithms, and/or (iii) based on information programmed directly into the intelligent edge devices. Once intelligent edge devices 110 are aware of each other, the intelligent edge devices 110 may begin forming trusted relationships with each other, where certificates may be shared, and secure, encrypted channels may be built between intelligent edge devices 110. As a result, a trusted infrastructure domain 140 is created comprising, e.g., the controller 120 and the intelligent edge devices 110.

Once the trusted infrastructure is created, the intelligent edge devices 110 are configured to collect baseline and dynamic persona information for their respective clients 130. As mentioned above, the baseline persona information comprises persona information from when the client initiated the network session (e.g. initial port information, initial client information, initial authentication information, initial connection membership information, initial dynamic policy information, and/or initial session state information). And the dynamic persona information comprises persona information modified subsequent to the initiation of the network session (e.g. modified port information, modified client information, modified authentication information, modified connection membership information, modified dynamic policy information, and/or modified session state information). Hence, in addition to storing the settings from when the client 130 initiated the network session, the intelligent edge devices 110 are configured to track and store the settings modified during the session. As a result, when another intelligent edge device 110 requests client information in response to a client roaming, the intelligent edge device 110 can provide up-to-date persona information to the requesting device. Alternatively, the intelligent edge devices 110 can send such information periodically or in response to changes in persona information. In addition, the intelligent edge devices 110 may provide historical persona information for statistical purposes, or to be used in the event that a current persona setting cannot be implemented and an earlier persona setting may need to be utilized.

Each intelligent edge device 110 is configured to store baseline and dynamic persona information for at least their respective clients in an internal memory. For example, each intelligent edge device 110 may comprise one or more databases to store persona information for various clients. In response to a change in parameters, a request, or periodically, each intelligent edge device 110 is configured to transmit the baseline and/or dynamic persona information for a client directly to another intelligent edge device. In addition, each intelligent edge device 110 may be configured to transmit the baseline and dynamic persona information for a client to the controller 120. Such transmission may occur via, e.g., Google protocol buffers or the like. Furthermore, it should be noted that the baseline and/or dynamic persona information may be stored in an encrypted manner within each intelligent edge device 110 and/or controller 120.

The controller 120 is configured to manage one or more services for the plurality of intelligent edge devices 110. For example, the controller 120 may conduct or otherwise support quality of service (QoS), firewall, management, connectivity, performance, mobility, and/or security services for at least the plurality of intelligent edge devices 110. Further, the controller 120 is configured to adopt the plurality of intelligent edge devices 110 and inform each about the other intelligent edge devices 110 that are proximate to the intelligent edge device so that a trusted infrastructure domain 140 may be created. It should be noted that the controller 120 may comprise one or more controllers in accordance with embodiments.

As mentioned above, the controller 120 is not responsible for distributing persona information for every client roaming within the trusted infrastructure domain. Rather, the intelligent edge devices 110 may communicate directly with one another, and all persona traffic does not have to be routed through the controller 120. Hence, the controller 120 does not create a bottleneck or introduce latency, as is the case with conventional systems.

The client 130 is a user device that connects to the edge device 110 (e.g., a laptop, desktop, tablet, smart phone, medical instrument, scientific instrument, etc.). in certain implementations, the persona information for a particular client may be based at least in part on the user associated with the client and/or the network.

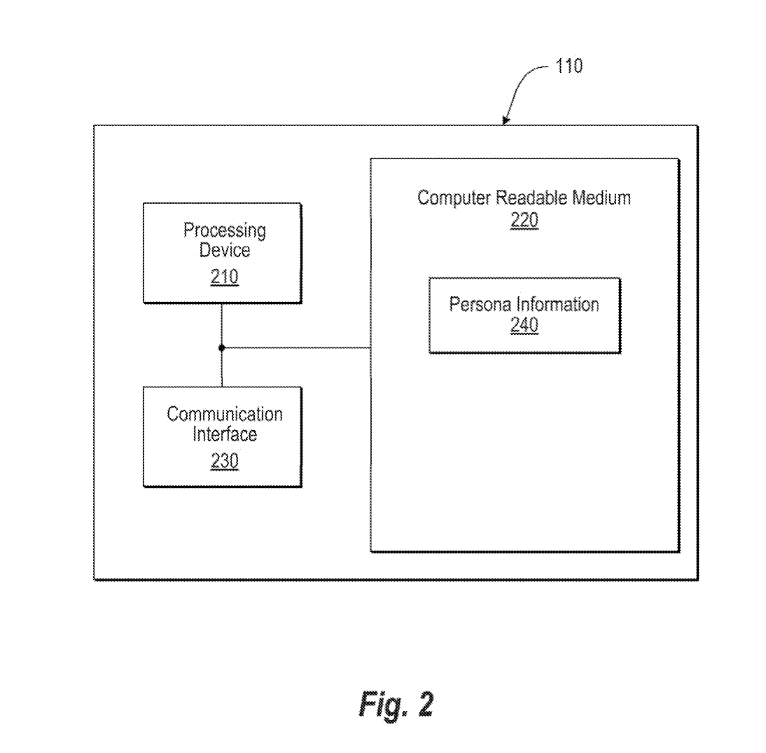

FIG. 2 depicts an intelligent edge device 110 in accordance with one embodiment. It should be readily apparent that the intelligent edge device 110 depicted in FIG. 1 represents a generalized illustration and that other components may be added or existing components may be removed, modified, or rearranged without departing from a scope of the present disclosure. The intelligent edge device 110 comprises a processing device 210, a computer readable medium 220, and a communication interface 230, each of which is described in greater detail below.

The processing device 210 is configured to retrieve and execute instructions stored in the computer readable medium 220. The processing device 210 may be, for example, a processor, a central processing unit (CPU), a microcontroller, or an application specific integrated circuit (ASIC). The computer readable medium 220 may be a non-transitory computer-readable medium configured to store machine readable instructions, codes, data, and/or other information (e.g., persona information 240). The computer readable medium 220 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In certain embodiments, the computer readable medium 220 may be integrated with the processing device 210, while in other embodiments, the computer readable medium 220 may be discrete from the processing device 210.

The communication interface 230 is configured to transmit and receive data. Such data may comprise at least the types of data described throughout this disclosure. The communication interface 230 may comprise one or more components such as for example, transmitters, receivers, transceivers, antennas, ports, and/or PHYs. It should be understood that the communication interface 230 may comprise multiple interfaces, and that each may serve a different purpose (e.g., to interface with the client, to interface with the wired infrastructure, etc.). The communication interface 230 is configured to receive persona information 240 for a client communicatively coupled to the intelligent edge device, and further configured to transmit the persona information 240 for the client to at least one proximate intelligent edge device.

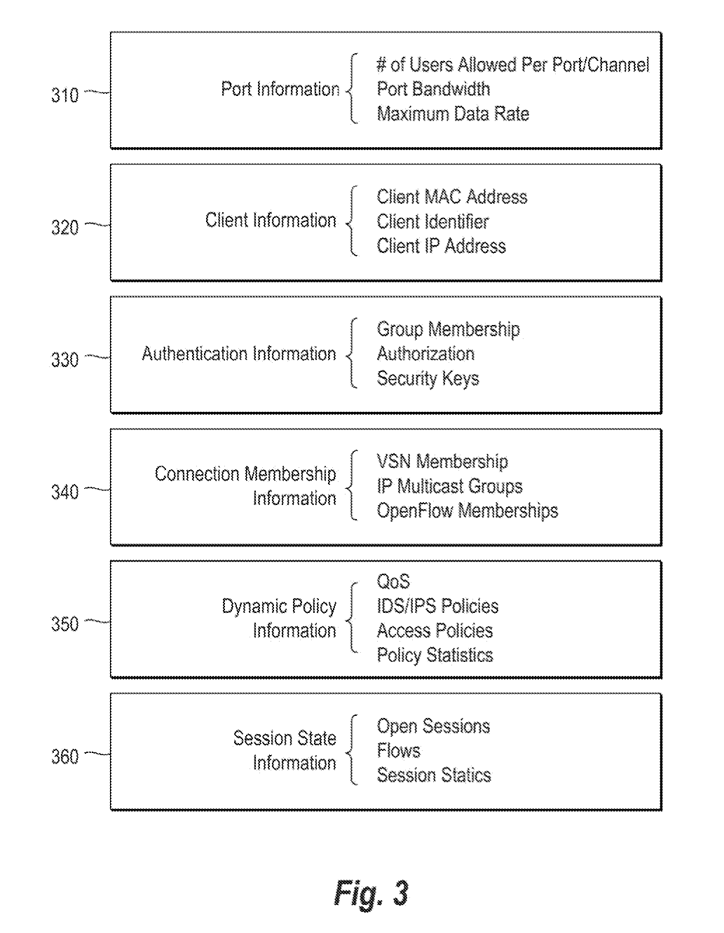

FIG. 3 depicts example persona information that may be collected, stored, and distributed by an intelligent edge device 110 for a client in accordance with an embodiment. It should be understood that the persona information depicted is merely an example, and that different persona information may be collected, stored, and distributed without departing from the scope of the present disclosure.

One type of information that may be collected and distributed is port information 310. This port information 310 may comprise (i) the number of users allowed per port/channel (e.g., 16 users per port/channel), (ii) the port bandwidth (e.g., 54 Mbps), and/or (iii) the port maximum data rate (e.g., 54 Mbps).

Another type of information that may be collected and distributed is client information 320. This client information 320 may comprise (i) a client MAC address (e.g., 12:34:56:78:ab), (ii) a client identifier (e.g., joeuser), and/or (iii) a client IP address (e.g., 10.110.135.51 (ipv4) and 2002:12d5:b8d7:10d4:b8d7 (ipv6)).

A further type of information that may be collected and distributed is authentication information 330. The authentication information 330 may comprise (i) group membership information (e.g., authuser, finance, management), (ii) authorization information (e.g., 0x0:unauthorized, 0x1:authorized, 0x2:forbid/blocked, 0x3:guest, or 0x4:quararitined), and/or (iii) security keys (e.g., 1a2b3c4d).

A still further type of information that may be collected and distributed is connection membership information 340. The connection membership information 340 may comprise (i) virtual service network (VSN) memberships (e.g., management and infrastructure), (ii) IP multicast groups (e.g., 10.110.135.51 (ipv4) and 2002:12d5:b8d7:10d4:b8d7 (ipv6)), and/or (iii) OpenFlow memberships (e.g., HP1switch and HP2switch).

An additional type of information that may be collected and distributed is dynamic policy information 350. The dynamic policy information 350 may comprise (i) quality of service (QoS) information (e.g., hex array of QoS, type of service (ToS), and DiffSrv values), (ii) intrusion detection/prevention system (IDS/IPS) policy information (e.g., 0x0:open, 0x1:restricted, 0x2:forbid/blocked, 0x3:capture, 0x4:quarantined, 0x5:limited), (iii) access policy information (e.g., date/time restrictions), and (iv) policy statistics (e.g., hex value array of policy statistics). Still further, the dynamic policy information may comprise routing information for having a client redirected to an IDS/IPS system (e.g., 10.110.135.51 (ipv4) and 2002:12d5:b8d7::10d4:b8d7 (ipv6)),

A further type of information that may be collected and distributed is session state information 360. The session state information 360 may comprise (i) open session information (e.g., hex value array of open session identifiers), (ii) flows information (e.g., hex value array of Flow identifiers with source/destination address/port —i.e., source1:sourceport1:destination1:destinationport1), and (iii) session statistic information (e.g., hex value array of session statistics).

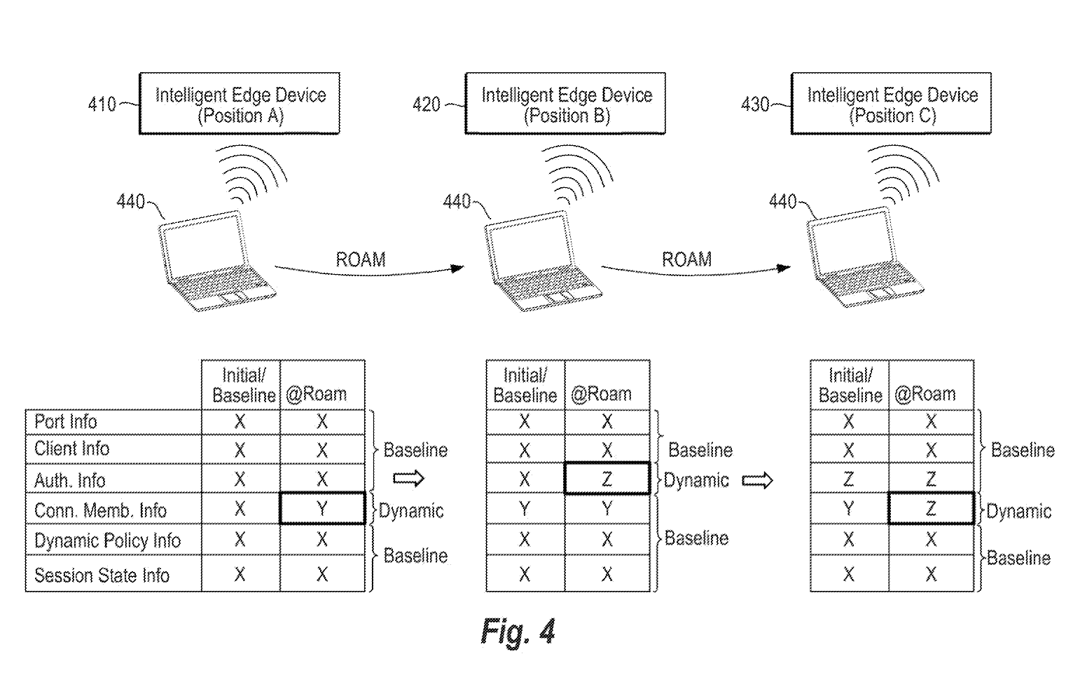

The above-described types of information may form the baseline and/or dynamic persona information collected, stored, and distributed by the intelligent edge devices. For instance, and as described in greater detail below with reference to FIGS. 4-8, the baseline persona information for a client that initiates a network session may include port information 310, client information 320, authentication information 330, connection membership information 340, dynamic policy information 350, and session state information 360. If such baseline persona information changes during the network session, the changed persona information is considered to be dynamic persona information, and that dynamic persona information is transmitted to other intelligent edge devices. As described below with reference to FIGS. 4-8, there are instances where no information changes during the network session, and therefore only baseline persona information is distributed, Similarly, there are instances where some persona information changes while other persona information does not change, and therefore baseline and dynamic persona information are distributed. These instances, as well as other example instances are explained in greater detail below with reference to FIGS. 4-8.

FIG. 4 graphically depicts how persona information may be collected, stored, and distributed in accordance with an embodiment. In particular, FIG. 4 depicts a first intelligent edge device 410 at position A, a second intelligent edge device 420 at position B, and a third intelligent edge device 430 at position C, where the client 440 roams from position A to position B to position C, and the persona information changes at positions A, B, and C. It should be noted that FIGS. 4-6 depict an implementation where persona information is transmitted when the client roams in response to a request (as opposed to other implementations where the persona information is distributed periodically or when persona changes occur).

As shown, the client 440 begins the network session at position A with the first intelligent edge device 410. When the client initiates the session with the first intelligent edge device 410, the initial/baseline settings are “X.” During the network session, however, the connection membership information changes from “X” to “Y”. When the client roams to position B, the second intelligent edge device 420 transmits a request for persona information to all intelligent edge devices in the trusted infrastructure domain. The first intelligent edge device 410 receives this request and responds with the up-to-date persona information for the client 440. In this case, the response comprises the baseline persona information that has not changed since initiation of the network session (i.e., port information, client information, authentication information, dynamic policy information, and session state information) and the dynamic persona information that has changed since the initiation of the network session (i.e., connection membership information). The second intelligent edge device 420 receives the baseline and dynamic persona information from the first intelligent edge device 410, and this information becomes the initial/baseline persona information for the client 440 at the second intelligent edge device 440.

During the session with the second intelligent edge device 420, the authentication information changes from “X” to “Z.” Therefore, when the client roams to position C serviced by the third intelligent edge device 430, the second intelligent edge device 420 receives a request for persona information from the third intelligent edge device 430 and responds with up-to-date persona information comprising the baseline persona information that has not changed since initiation of the network session with the second intelligent edge device 420 (i.e., port information, client information, connection membership information, dynamic policy information, and session state information) and dynamic persona information that has changed since the initiation of the network session with the second intelligent edge device 420 (i.e., authentication information). This baseline and dynamic persona information then becomes the initial/baseline persona information for the third intelligent edge device 430.

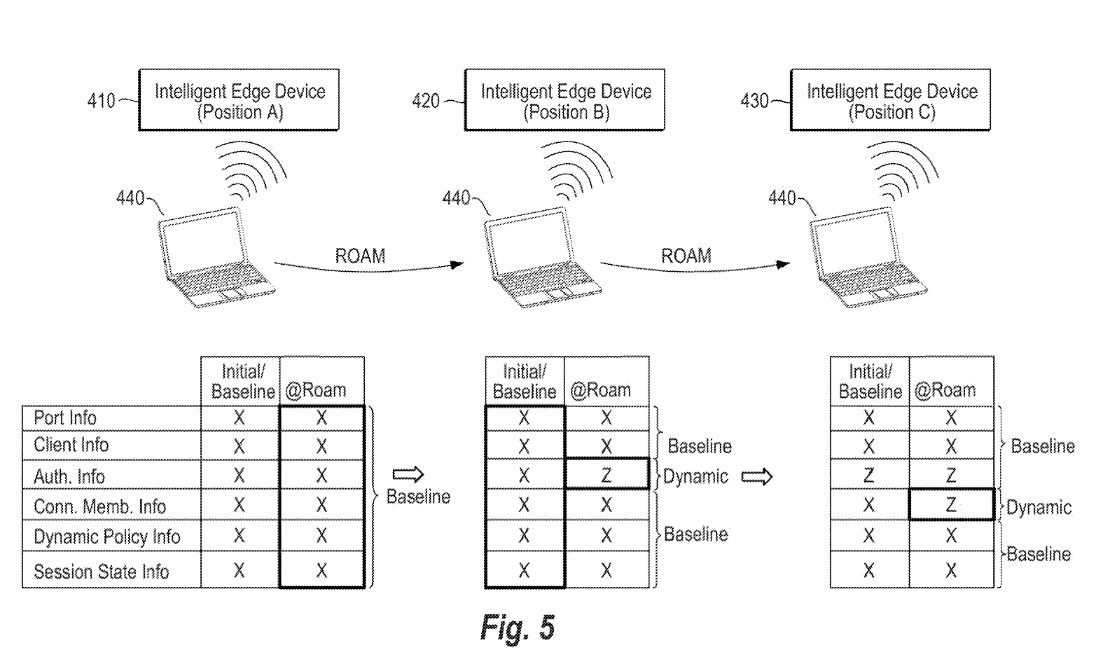

FIG. 5 graphically depicts how persona information may be collected, stored, and distributed in accordance with another embodiment. Similar to FIG. 4, FIG. 5 depicts a first intelligent edge device 410 at position A, a second intelligent edge device 420 at position B, and a third intelligent edge device 430 at position C, where the client 440 roams from position A to position B to position C. Unlike FIG. 4, however, persona changes do not occur at each position. For example, the client 440 begins the network session at position A with the first intelligent edge device 410 with initial/baseline settings “X.” During the session with the first intelligent edge device 410, the persona parameters do not change. Thus, when client 440 roams to position B associated with the second intelligent edge device 420, the first intelligent edge device 410 provides the baseline persona information to the second intelligent edge device 420 in response to a request from the second intelligent edge device 420. Stated differently, the first intelligent edge device 410 does not provide dynamic persona information to the second intelligent edge device 420 because no persona changes occurred after the initiation of the session with the first intelligent edge device 410. By contrast, at position B associated with the second intelligent edge device 420, the authentication information for the client 440 changes from “X” to “Z.” As a result, when the client roams to the third intelligent edge device 430, the second intelligent edge device 420 provides up-to-date persona information comprising the baseline persona that has not changed since initiation of the network session (i.e. port information, client information, connection membership information, dynamic policy information, and session state information) and the dynamic persona information that has changed since the initiation of the network session with the second intelligent edge device 420 (i.e., the authentication information). This baseline and dynamic persona information then becomes the baseline persona at the third intelligent edge device 430.

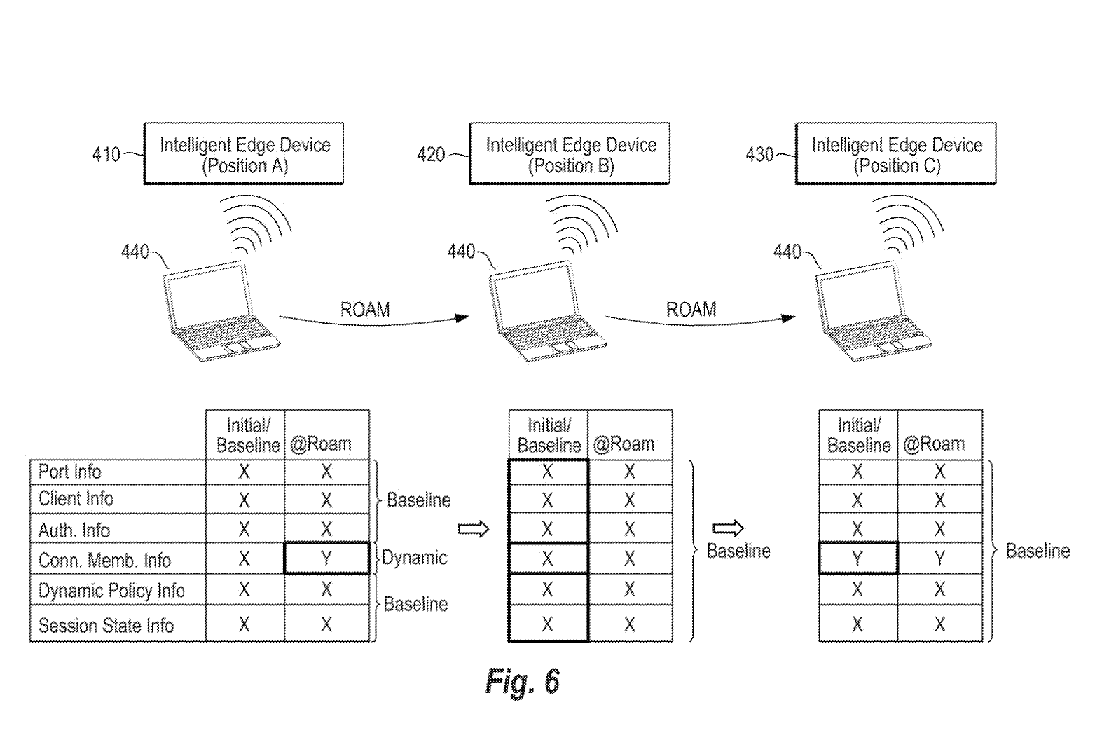

FIG. 6 graphically depicts how persona information may be collected, stored, and distributed in accordance with still another embodiment. In this embodiment, in addition to providing the up-to-date persona baseline and/or dynamic persona information as described in FIGS. 4 and 5, historical persona information is also provided at each roam. Such historical persona information may be useful in situations where one intelligent edge device cannot provide a certain persona level but another intelligent edge device can. For example, in FIG. 6, the client's connection membership information changes from “X” to “Y” while at position A associated with the first intelligent edge device 410. Therefore, when the client 440 roams to position B associated with the second intelligent edge device 420, the first intelligent edge device 410 provides up-to-date persona information comprising the baseline persona information that has not changed since initiation of the network session with the first intelligent edge device 410 (i.e. port information, client information, authentication information, dynamic policy information, and session state information) and the dynamic persona information that has changed since the initiation of the network session with the first intelligent edge device 410 (Le., the connection membership information). In addition to the baseline and dynamic information, the first intelligent edge device 410 also provides historical data for the client 440 comprising the initial/baseline settings from when the client 440 initiated the session with the first intelligent edge device 410. The second intelligent edge device 420 receives this information and determines that it cannot support the connection membership level “Y” provided by the first intelligent edge device 410. The second intelligent edge device 420 then refers to the historical information provided and determines that the client was previously provided connection membership level “X,” which can be supported by the second intelligent edge device 420. The second intelligent edge device 420, therefore, implements connection membership level “X” for the client 440. Hence, the historical persona information may be utilized by the intelligent edge devices to provide a previous persona level if the most recent persona level cannot be supported by the intelligent edge device.

When the client later roams to the third intelligent edge device 430, the third intelligent edge device 430 receives up-to-date persona information as well as historical persona information. Based on the historical persona information, the third intelligent edge device 430 determines that the client previously had a connection membership level of “Y” at the first intelligent edge device 410, and this service level was not implemented at the second intelligent edge device 420 because the second intelligent edge device 420 could not support connection membership level “Y.” Therefore, instead of implementing connection membership level of “X” as was being provided by the second intelligent edge device 420, the third intelligent edge device 430 implements connection membership level “Y” because the third intelligent edge device 430 can support connection membership level “Y.” Hence, the historical persona information may be utilized by the intelligent edge devices to provide the highest supportable persona level desired by the client, even if this persona level was not being provided by the most recent intelligent edge device.

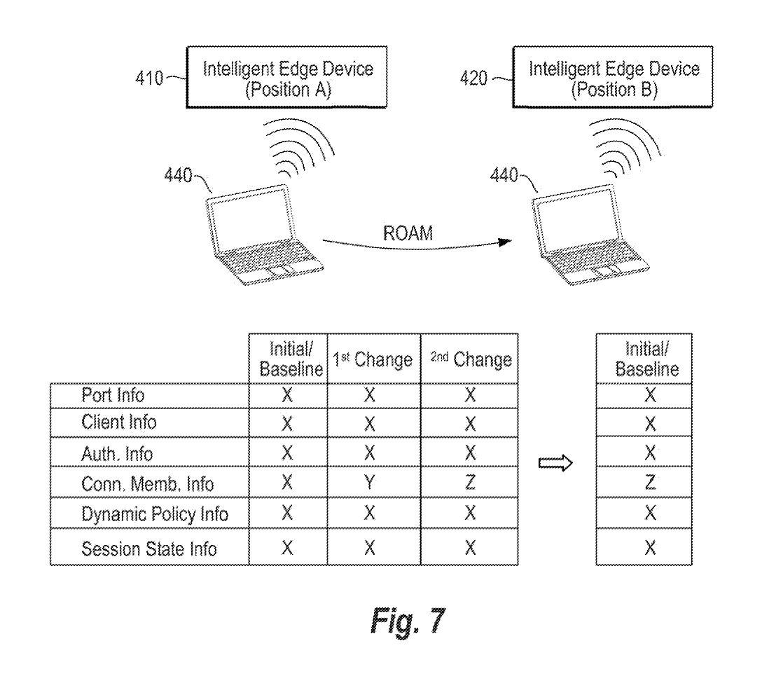

FIG. 7 graphically depicts how persona information may be collected, stored, and distributed in accordance with a further embodiment. In particular, in the implementation depicted in FIG. 7, the first intelligent edge device 410 distributes persona information each time persona changes occur. For example, when the client 440 initiates a session with the first intelligent edge device 410, the connection membership information may be “X.” At a later point, this connection membership information may change to “Y.” When this change occurs, the first intelligent edge device 410 may inform all other intelligent edge devices in the trusted infrastructure domain about the change. This may involve the first intelligent edge device 410 distributing only the dynamic persona information (i.e., connection membership information=“Y”), or may involve the first intelligent edge device 410 distributing the baseline and persona information (i.e., port information=“X,” client information=“X,” authentication information=“X,” connection membership information=“Y,” dynamic policy information=“X,” and session state information“X”). Regardless of the distribution technique, the other intelligent edge devices are informed of the client's up to date persona information and the change to the connection membership information. If the connection membership information changes at a later point to “Z,” the first intelligent edge device 410 again distributes information about the persona change to the other intelligent edge devices in the trusted infrastructure domain. Thus, when the client 440 roams to position B associated with the second intelligent edge device 420, the second intelligent edge device has up-to-date persona information for the client and does not have to send out a request/query for persona information for the client. The second intelligent edge device 420, therefore, proceeds to implement a persona based on the most recent information received (i.e., connection membership information=“Z”).

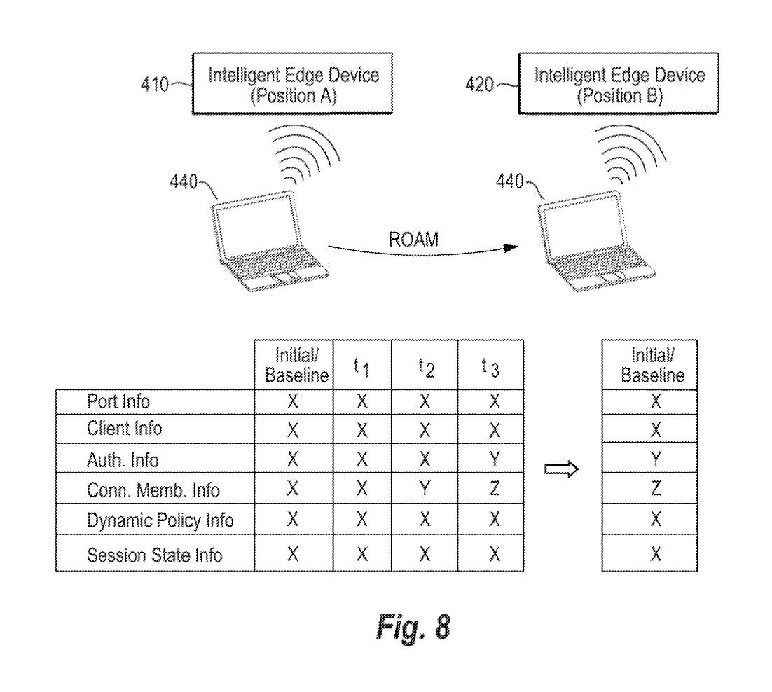

FIG. 8 graphically depicts how persona information may be collected, stored, and distributed in accordance with another embodiment. More specifically, in the implementation depicted in FIG. 8, the first intelligent edge device 410 periodically distributes persona information. For example, at times t₁, t₂, and t₃, the first intelligent edge device 410 distributes current persona information for the client 440 (i.e., baseline and/or dynamic persona information) to all other intelligent edge devices in the trusted infrastructure domain. Thus, when the client 440 roams to position B associated with the second intelligent edge device 420, the second intelligent edge device has up-to-date persona information for the client and dues not have to send out a request/query for persona information for the client. The second intelligent edge device 420, therefore, proceeds to implement a persona based on the most recent information received (i.e., authentication information=“Y” and connection membership information=“Z”).

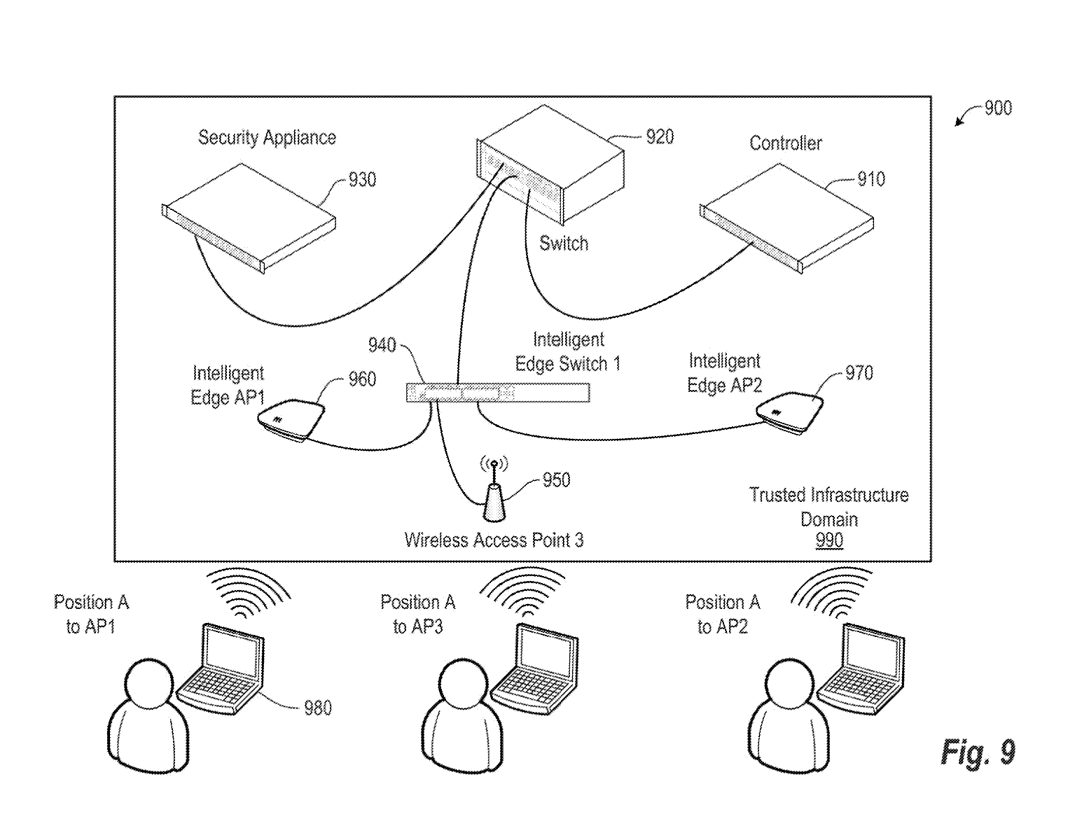

FIG. 9 depicts a system 900 in accordance with a further embodiment. The system comprises a controller 910, a switch 920, a security appliance 930, an intelligent switch 940, a “non-intelligent” access point 950, a first intelligent access point 960, a second intelligent access point 970, a client 980, and a trusted infrastructure domain 990.

The controller 910, the first intelligent access point 960, the second intelligent access point 970, the intelligent edge switch 940, and the trusted infrastructure domain 990 are similar to those described above with respect to FIG. 1, The security appliance 930 is a device such as an intrusion prevention system (IPS) or intrusion detection system (IDS) configured to protect the network by conducting processes such as authorization, authentication, deep packet inspection (DPI), etc. The switch 920 is a switching device 920 that communicatively couples various components such as the security appliance 930, the controller 910, and the intelligent edge switch 940. The “non-intelligent” access point 950 is an ordinary access point, but when combined with the intelligent edge switch 940, the combination may work together to provide the intelligent features such as collecting, storing, and distributing persona information without or with partial conjunction of the controller 910, as described above. Thus, the client 980 can move from the first intelligent access point 960 to the “non-intelligent” access point 950 to the second intelligent access point 970 and receive consistent service with minimal delay because baseline and/or dynamic persona information may be propagated from the first intelligent access point 960 to the “intelligent edge switch 940 to the second intelligent access point 970 in response to persona changes, in response to persona requests, or periodically.

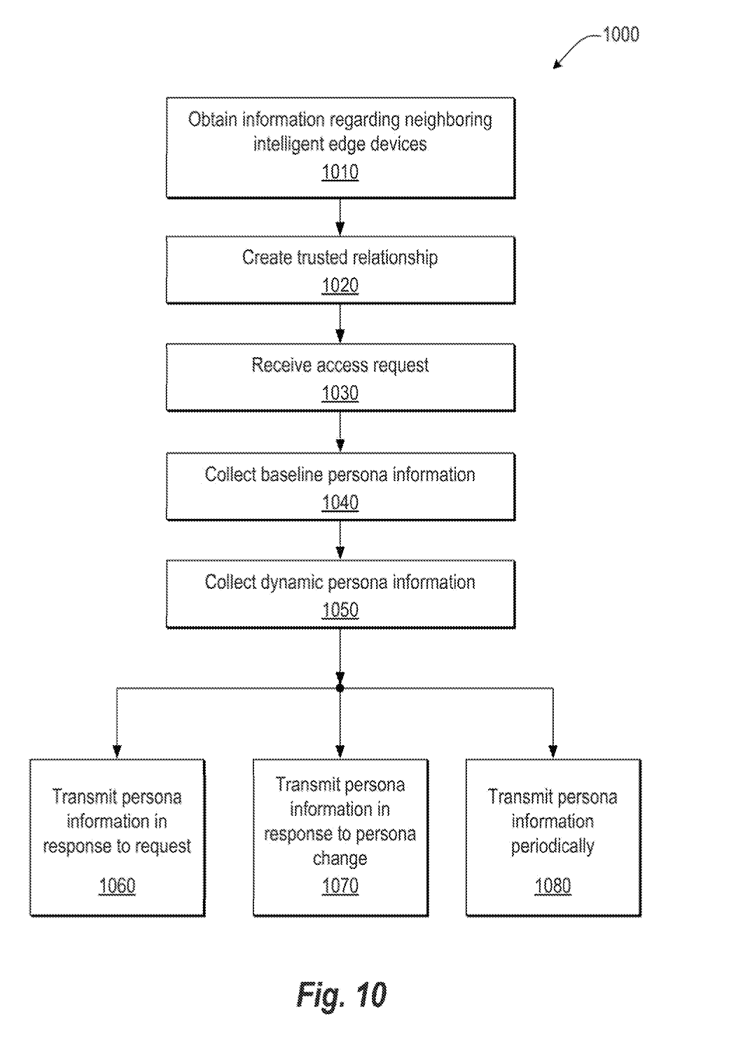

FIG. 10 depicts a process flow diagram 1000 in accordance with an embodiment. More specifically, FIG. 10 depicts processes that may be conducted by an intelligent edge device 110 in accordance with an embodiment.

The process may begin at block 1010, where the intelligent edge device 110 obtains information about neighboring intelligent edge devices. Such information may be (0 provided by a controller, (ii) determined locally by the intelligent edge device based on various algorithms (e.g., via wireless probing), and/or (iii) programmed directly into the intelligent edge device. At block 1020, the intelligent edge device 110 creates a trusted relationship with the neighboring intelligent edge devices. This may involve sharing certificates and/or setting up secure communication channels. At block 1030, the intelligent edge device 110 receives an access request from a client. If the various network components grant the client access to the network, the intelligent edge device 110, at block 1040, collects baseline persona information for the client. As mentioned above, such baseline persona information may include initial port information, initial client information, initial authentication information, initial connection membership information, initial dynamic policy information, and/or initial session state information. Thereafter, during the network session and if persona changes occur, the intelligent edge device 110 collects dynamic persona information for the client at block 1050. As mentioned above, such dynamic persona information may include modified port information, modified client information, modified authentication information, modified connection membership information, modified dynamic policy information, and/or modified session state information. The intelligent edge device 110 then either distributes the baseline and/or dynamic persona information to one or more other intelligent edge devices and/or a controller in response to a request for persona information (block 1060), in response to persona changes (block 1070), or periodically (block 1080).

The present disclosure has been shown and described with reference to the foregoing exemplary embodiments. It is to be understood, however, that other forms, details, and embodiments may be made without departing from the spirit and scope of the disclosure that is defined in the following claims.

What is claimed is:

1. A system comprising:
a controller to adopt a plurality of intelligent edge devices and inform each of the plurality of intelligent edge devices which of the other plurality of intelligent edge devices are proximate to the intelligent edge device; and
the plurality of intelligent edge devices, wherein each of the plurality of intelligent edge devices is to
create a trusted relationship with the other plurality of intelligent edge devices that are proximate to the intelligent edge device;
collect baseline persona information for a client connected to the intelligent edge device;
collect dynamic persona information for the client connected to the intelligent edge device;
store the baseline and dynamic persona information for the client connected to the intelligent edge device; and
transmit the baseline and dynamic persona information for the client to at least one of the other plurality of intelligent edge devices that are proximate to the intelligent edge device.

2. The system of claim 1, wherein the baseline persona information comprises persona information from when the client initiated the network session, and the dynamic persona information comprises persona information modified after the client initiated the network session.

3. The system of claim 1, wherein the baseline persona information comprises at least one of port information, client information, authentication information, connection membership information, dynamic policy information, and session state information.

4. The system of claim 1, wherein each of the plurality of intelligent edge devices is to transmit the baseline persona information and the dynamic persona information to at least one of the other plurality of intelligent edge devices in response to receiving a query message requesting information for the client.

5. The system of claim 1, wherein each of the plurality of intelligent edge devices is to transmit at least the dynamic persona information to at least one of the other plurality of intelligent edge devices in response to persona information changes for the client.

6. The system of claim 1, wherein each of the plurality of intelligent edge devices is to further transmit historical persona information to at least one of the other plurality of intelligent edge devices.

7. The system of claim , wherein each of the plurality of intelligent edge devices is to transmit at least one of the baseline and dynamic persona information for the client directly to the at least one of the other plurality of intelligent edge devices.

8. An intelligent edge device comprising:
a processing device;
a communication interface to receive persona information for a client communicatively coupled to the intelligent edge device, and to transmit baseline persona information and dynamic persona information for the client to at least one proximate intelligent edge device in response to receiving, a query message requesting information for the client from the proximate intelligent edge device, or in response to persona information changes for the client; and
a non-transitory computer readable medium to store the baseline persona information and the dynamic persona information for the client communicatively coupled to the intelligent edge device.

9. The intelligent edge device of claim 8, wherein the communication interface is further to transmit the baseline persona information and the dynamic persona information for the client to a controller.

10. The intelligent edge device of claim 8, wherein the intelligent edge device comprises an intelligent edge access point or an intelligent edge switch.

11. The intelligent edge device of claim 8, wherein the intelligent edge device and the at least one proximate intelligent edge device are within a trusted infrastructure domain created based at least in part on information provided by a controller.

12. The intelligent edge device of claim 8, wherein the intelligent edge device is to identify the at least one proximate intelligent edge device without assistance of a controller.

13. A non-transitory computer-readable medium comprising instructions that when executed cause a first intelligent edge device to:
create a trusted relationship with a second intelligent edge device based at least in part on information provided by a controller;
collect and store baseline persona information and dynamic persona information for a client communicatively coupled to the first intelligent edge device; and
transmit, directly to the second intelligent edge device, the baseline persona information and the dynamic persona information for the client.

14. The non-transitory computer-readable medium of claim 13, wherein the intelligent edge device comprises an intelligent edge access point or an intelligent edge switch.

15. The non-transitory computer-readable medium of claim 13, wherein the instructions further cause the first intelligent edge device to transmit the baseline persona information and the dynamic persona information to the second intelligent edge device in response to the client roaming from the first intelligent edge device's coverage area to the second intelligent edge device's coverage area.
